(19) United States
(12) Patent Application Publication
(10) Pub. No.: US 2014/0279548 A1
(43) Pub. Date: Sep. 18, 2014

(54) Systems and Methods to Provide Product Information to Consumers

(71) Applicant: eCheckID Corporation, Menlo Park, CA (US)

(72) Inventors: Jiang Hua Wang, Gurnee, IL (US); Serena HanYing Wong, Atherton, CA (US); Ying-Hon Wong, Atherton, CA (US)

(73) Assignee: eCheckID Corporation, Menlo Park, CA (US)

(21) Appl. No.: 14/200,618

(22) Filed: Mar. 7, 2014

Related U.S. Application Data
(60) Provisional application No. 61/790,149, filed on Mar. 15, 2013.
(60) Provisional application No. 61/875,025, filed on Sep. 7, 2013.

(51) Int. Cl. G06Q 30/00; G06Q 30/02

(52) U.S. Cl. CPC G06Q 30/012; G06Q 30/0255
USPC 705/50

(57) ABSTRACT

Consumers are encouraged to register products that they purchase so that manufacturers can send updates about the purchased products, marketing offers, or other materials. However, processes in place to register products can be cumbersome and time-consuming so many consumers do not register the products that they use. Some consumers may rely on a purchase history maintained by select retailers but these purchase histories do not track purchases made by or for other consumers or purchases made by the consumer at other retailers. A third party server allows consumers to register products from multiple manufacturers via a consumer device. The registration is separate from the consumer's purchase history maintained by the retailers. Using the third party server, manufacturers can distribute product information and, subsequently, updated product information to the consumers based on the product registrations.

### CLAIM OF PRIORITY

This nonprovisional patent application claims the priority benefit of U.S. Provisional Patent Application No. 61/790,149 filed Mar. 15, 2013 and U.S. Provisional Patent Application No. 61/875,025 filed Sep. 7, 2013, both of which are incorporated by reference in their entirety.

### BACKGROUND

1. Field

This patent application is generally related to data management and network communications and, more specifically, to systems and methods to provide product information to consumers.

2. Description of Related Art

When a person purchases an item in a brick and mortar store or online, a purchase record is created that details the item purchased, payment information, when the purchase occurred, and other information. Existing consumer systems for tracking purchases rely on these purchase records created at the time of sale to provide product recommendations to the purchaser. The purchase records may store sensitive information such as purchaser name, credit card data, home address, and other personally identifiable information (PII) along with an identification of the item purchased. Further, purchase records identify only the purchaser of the item, not the actual end-user of the item if, for example, the item was purchased as a gift or for a family member. While some retailers allow a purchaser to indicate that the item was purchased as a gift, purchasers often choose to skip this additional step.

The purchase records are stored, managed, and maintained by a retailer who sold the item to the purchaser. To access the purchase records, the purchaser logs in to a retailer website hosted by the retailer, if such website exists, from whom the purchaser purchased the item. As such, to maintain an inventory of items that the user has purchased, the user is required to remember which retailer the item was purchased from and to separately manage log in information for each retailer from whom the purchaser has purchased an item. The purchaser is unable to access a unified account with information about all of the products that the purchaser has purchased.

After an item is purchased, the manufacturer of the item may publish additional information about the item. Typically, the manufacturer, at great cost, accesses registration records and individually contacts each consumer who purchased and registered the product. This process can be complicated in that many consumers do not register products that they intend to use or consume quickly due to the relatively large amount of effort required for seemingly little benefit. The manufacturer may post information on a website or communicate via mass media. However, the consumer may not know to check for additional information. Some retailers may, based on purchase records, notify a previous purchaser of the item of the new information.

However, these systems are cumbersome to use and maintain because the relevant data is widely distributed across many different entities. The response time of the manufacturers or retailers that collect and distribute such data is not real-time or hassle-free. As such, many consumers do not use the systems or rely on the system of only one or two retailers of many retailers, risking non-receipt of important notifications. The prior art systems often result in people not receiving relevant information or failing to act on relevant information.

### SUMMARY

A method comprises receiving, across a network and from a manufacturer system, product information, a decryption key, and a unique identifier, the product information describing a product to which an encrypted version of the unique identifier is affixed by the manufacturer; storing the decryption key; storing the product information along with the unique identifier received from the manufacturer system; receiving, across the network and from a device of a consumer, consumer registration information and a scan of the encrypted version of the unique identifier, the consumer registration information including an identification of the consumer; decrypting the received encrypted version of the unique identifier using the stored decryption key, resulting in a decrypted unique identifier; matching the stored unique identifier to the decrypted unique identifier; registering the product to the consumer by storing the consumer registration information in association with the stored unique identifier; retrieving the product information stored along with the stored unique identifier; sending the retrieved product information across the network to the device of the consumer; receiving, across the network and from the manufacturer system, updated product information along with the unique identifier; matching the unique identifier received with the updated product information to the stored unique identifier; storing the updated product information along with the stored unique identifier; identifying the consumer to whom the product is registered using the consumer registration information stored in association with the stored unique identifier; retrieving the updated product information stored along with the stored unique identifier; and sending the retrieved updated product information across the network to the device of the consumer.

A system comprises a manufacturer system communication module configured to receive, across a network and from a manufacturer system, product information, a decryption key, and a unique identifier, the product information describing a product to which an encrypted version of the unique identifier is affixed by the manufacturer, to store the decryption key, and to store the product information along with the unique identifier received from the manufacturer system; a consumer device communication module configured to receive, across the network and from a device of a consumer, consumer registration information and a scan of the encrypted version of the unique identifier, the consumer registration information including an identification of the consumer, a match module configured to decrypt the received encrypted version of the unique identifier using the stored decryption key, resulting in a decrypted unique identifier, and to match the stored unique identifier to the decrypted unique identifier; a registration module configured to register the product to the consumer by storing the consumer registration information in association with the stored unique identifier; and a retrieval module configured to retrieve the product information stored along with the stored unique identifier, wherein the consumer device communication module is further configured to send the retrieved product information across the network to the device of the consumer, wherein the manufacturer system communication module is further configured to receive, across the network and from the manufacturer system, updated product information along with the unique identifier, wherein the match module is configured to match the unique identifier received with the updated product information to the stored unique identifier, and to store the updated product information along with the stored unique identifier, wherein the match module is further configured to identify the consumer to whom the product is registered using the consumer registration information stored in association with the stored unique identifier, wherein the retrieval module is further configured to retrieve the updated product information stored along with the stored unique identifier, and wherein the consumer device communication module is further configured to send the retrieved updated product information across the network to the device of the consumer.

A non-transitory computer-readable medium has instruction embodied thereon, the instructions executable by one or more processors to perform operations comprising receiving, across a network and from a manufacturer system, product information, a decryption key, and a unique identifier, the product information describing a product to which an encrypted version of the unique identifier is affixed by the manufacturer; storing the decryption key; storing the product information along with the unique identifier received from the manufacturer system; receiving, across the network and from a device of a consumer, consumer registration information and a scan of the encrypted version of the unique identifier, the consumer registration information including an identification of the consumer; decrypting the received encrypted version of the unique identifier using the stored decryption key, resulting in a decrypted unique identifier; matching the stored unique identifier to the decrypted unique identifier; registering the product to the consumer by storing the consumer registration information in association with the stored unique identifier; retrieving the product information stored along with the stored unique identifier; sending the retrieved product information across the network to the device of the consumer; receiving, across the network and from the manufacturer system, updated product information along with the unique identifier; matching the unique identifier received with the updated product information to the stored unique identifier; storing the updated product information along with the stored unique identifier; identifying the consumer to whom the product is registered using the consumer registration information stored in association with the stored unique identifier; retrieving the updated product information stored along with the stored unique identifier; and sending the retrieved updated product information across the network to the device of the consumer.

### DESCRIPTION OF THE DRAWINGS

FIG. 1 is a diagram of an example computing environment in which various embodiments are implemented.

FIG. 2 is a block diagram of an example system to provide product information to consumers.

FIGS. 3A and 3B comprise a flowchart of an example method to provide product information to consumers.

FIG. 4 is a flowchart of an example method to provide additional information to consumers.

FIG. 5 is a flowchart of an example method to provide marketing offers to consumers.

FIG. 6 is a flowchart of an example method to track consumption by consumers of a product.

FIG. 7 is a flowchart of an example method to identify fraudulent uses of the product.

FIG. 8 is an example of a data structure in which data is stored according to various embodiments.

### DETAILED DESCRIPTION

A third party server is configured to manage registration of products used by consumers and distribution of information to the consumers about the registered products. The third party server is in electronic communication with the respective manufacturer systems of a plurality of manufacturers and with devices of consumers. The third party server provides a centralized system for consumers to learn about products that they have purchased and for manufacturers to communicate with consumers while maintaining consumer privacy and without relying on retailers.

At some point during a manufacturing process, the manufacturer assigns a unique identifier to each instance of a product being manufactured and encrypts the unique identifier. The manufacturer affixes the encrypted unique identifier to each product. The unique identifier can identify the product, a group of instances of the product (e.g., by identifying the product and a batch or lot number), or a single instance of the product. The manufacturer sends the assigned unique identifiers and a key for decrypting the encrypted unique identifiers to the third party server. The manufacturer further provides product information about the products to the third party server.

A consumer, using a computing device such as a smartphone running an application or “app”, is able to register the product by scanning an encoded and encrypted unique identifier affixed to the product and sending the scan to the third party server. By registering the product, the consumer indicates that she owns, has consumed, or will consume the product. Because the consumer registers the product instead of relying on a purchase history stored by a retailer, the consumer need not have purchased the product from a particular retailer nor provide sensitive information (e.g., PII) to the third party server or to the manufacturer.

The third party server decrypts the received, encrypted unique identifier, and matches the decrypted unique identifier to one of the unique identifiers previously received from the manufacturer. The third party server registers the corresponding product to the consumer and sends product information from the manufacturer about the product to the device of the consumer. Over time, if updated product information is provided by the manufacturer, the updated product information is sent by the third party server to the devices of the consumers who have registered the corresponding product.

The third party server can send to the device of the consumer additional information or marketing offers from the manufacturer. The manufacturer indicates one or more unique identifiers of products along with the additional information or marketing offers. The manufacturer can additionally or alternatively provide other criteria such as demographic information about consumers or products which may have been previously registered to consumers. Using the indicated unique identifiers and/or the criteria, the third party server can identify consumers to receive the additional information or marketing offers based on the products registered to the consumer.

When the unique identifier identifies one instance of the product rather than multiple instances of the product, the third party server may perform additional functions. For example, the third party server can track usage or consumption of the instance of the product. In other embodiments, the unique identifier may be used to track fraudulent uses of the product, as described elsewhere herein.

FIG. 1 is a diagram of an example computing environment 100 in which various embodiments are implemented. The computing environment 100 is implemented as a computing network 106 over which entities may electronically communicate with one another. The entities within the computing environment 100 include manufacturer systems 102, the third party server 104, consumer devices 110, and retailers 108. Various ways to implement the computing environment 100 are known to those skilled in the art. In some instances, the entities may communicate over a public network, such as the Internet or World Wide Web (WWW).

Manufacturer systems 102 are hosted by manufacturers who comprise entities that manufacture products. The manufacturers include suppliers, producers or owners of merchandise or content, brand owners, exporters, master importers or distributors for a particular sales territory, artists, or other content creators. The manufacturers may separately maintain registries identifying consumers who have registered a product through other channels.

The manufacturer systems 102, or other systems and personnel under control of the manufacturers, assign and affix an encrypted and encoded unique identifier to instances of the product. The unique identifier may be generated in a number of ways, including those ways known in the art. The unique identifiers may be generated by combining existing identifiers such as a manufacturer identification code, factory code, product code, service provider code, date code, other codes indicating a product parameter, or a serial number. The same unique identifier can be assigned to multiple instances of a product, such as a batch or lot, or to all instances of the product. In some instances, a different unique identifier (e.g., a serial number) can be assigned to each instance of the product. The individual manufacturer systems 102 need not coordinate with one another when assigning codes to products.

The manufacturer systems 102 then encrypt the generated unique identifiers using encryption technology. Various encryption technologies are well known and familiar to those skilled in the art. In some instances, the encryption may be performed using a private key that is known only to the manufacturer. The encrypted unique identifier can then be encoded in a machine-readable format according to techniques known in the art. Examples of machine-readable formats include bar codes, quick response (QR) codes, data-glyphs, and data matrices.

The encoded, encrypted unique identifier can be affixed to each instance of the product using processes known in the art. In some instances, the encoded, encrypted unique identifier is affixed to the product itself. In other instances, the encoded, encrypted unique identifier is affixed to packaging containing the product, or to a label adhered to the packaging or to the product. The encoded, encrypted unique identifier can be printed, imprinted, embedded, or otherwise affixed to the product. In some instances, the encoded, encrypted unique identifier is positioned on the packaging such that it is only accessible once the package is unsealed or opened. In other instances, the encoded, encrypted unique identifier is destroyed when the package is opened or the product is consumed, such as when the packaging comprises a blister pack to which the encoded unique identifier is affixed.

Some products or packages of products may have more than one encoded, encrypted unique identifier affixed thereto that can be used to track usage or consumption of the product. For example, a first encoded, encrypted unique identifier is affixed externally to the product packaging and identifies the product. A second encoded or not encoded, encrypted or not encrypted unique identifier may be affixed such that it is only exposed when the packaging is opened or when a scratch-off seal removed. Either or both of the unique identifiers can identify the particular instance of the product or a batch or lot number.

The respective manufacturer systems 102 send the unencrypted unique identifiers, one or more decryption keys, and product information to the third party server 104 via the network 106. As described above, the unique identifiers are generated, encrypted, encoded, and affixed by the manufacturers independently of the third party server 104. The product information may include a written description, multimedia (e.g., images and videos), hyperlinks to such information, etc., about the product and/or the manufacturer. Instance-specific information may include product expiration date, batch identifier, or the like. Where the product is a consumable to be consumed over or within a period of time (e.g., a pharmaceutical or consumable product), the product information or instance-specific information may include an anticipated time of product consumption, interval of consumption, or expiration date.

The manufacturer then distributes the products through its normal distribution channels to consumers, including through direct order, online portals, and brick and mortar stores, such as retailers 108. Along the distribution channels, intermediaries may scan the encoded, encrypted unique identifiers to establish a shipping record or for other purposes.

The third party server 104 receives the unique identifiers, decryption keys, and product information from the manufacturer system 102. The third party server 104, as is described elsewhere herein, stores this data. When a consumer purchases the product to which an encoded, encrypted unique identifier is affixed, the consumer can scan the encoded, encrypted unique identifier using a consumer device 110. The consumer devices 110 are computing devices such as smartphones, portables or wearable devices, laptop or desktop computers, tablet computers, and the like. The consumer devices 110 include a camera or other image capture device that can be used to scan or capture an image of the encoded, encrypted unique identifier. In some instances, the consumer device 110 can decode the encoded, encrypted unique identifier. While in other instances where the encrypted unique identifier is encoded using a private, proprietary, or secret technique, the consumer device 110 can send the captured image of the encoded, encrypted unique identifier to the third party server 104. As used herein, the term, “an encrypted version of the unique identifier”, affixed to a product or received from a device of a consumer, is intended to include encoded, not encoded, and decoded instances of the encrypted unique identifier. The consumer devices 110 are configured to communicate with the third party server 104 via the network 106. An app installed on the respective consumer devices 110 communicates with the third-party server 104 and displays product information to the consumer.

FIG. 2 is a block diagram of an example third party server 104. In various embodiments, the third party server 104 comprises a manufacturer system communication module 202, a consumer device communication module 204, a match module 206, a registration module 208, a retrieval module 210, a database 212, an aggregation module 214, a marketing module 216, a usage module 218, and an authentication module 220. The third party server 104 may be implemented in a variety of ways known to those skilled in the art including, but not limited to, as a computing device having a processor with access to a memory capable of storing executable instructions. The computing device may include one or more input and output components, including components for communicating with other computing devices via a network (e.g., the network 106) or other form of communication. The third party server 104 comprises one or more modules embodied in computing logic or executable code such as software.

A manufacturer system communication module 202 is configured to receive data from the manufacturer systems 102 and to store, in the database 212, the data received from the manufacturer systems 102 for later retrieval based on matching unique identifiers. The manufacturer system communication module 202 sends information to the manufacturer system 102 such as data about registrations, feedback received from consumers about products, or the like.

The consumer device communication module 204 is configured to receive data from the consumer devices 110 and to store, in the database 212, the data received from the consumer devices 110 for later retrieval based on matching unique identifiers. The consumer device communication module 204 can receive a scan from the consumer device 110 of the encoded, encrypted unique identifier affixed to a product. In some instances, the consumer device 110 can decode the encoded, encrypted unique identifier before sending the scan to the third party server 104. The consumer device communication module 204 sends data such as product information, updated product information, and additional information to the consumer devices 110 based on, for example, the consumer registration information.

The match module 206 is then configured to decrypt the encrypted unique identifiers. In other embodiments, the match module 206 is configured to decode and decrypt encoded, encrypted unique identifiers to obtain the unique identifier. In some instances, the encoded unique identifier may include a manufacturer identifier or decryption key identifier that identifies the decryption key that can be used to decrypt the encrypted unique identifier. For example, the encoded, encrypted unique identifier may be a QR code that, when decoded, includes a uniform resource locator (URL) that identifies the manufacturer and the encrypted unique identifier. To illustrate, an example URL may be: http://www.echeckid.com/manfacturer=“abbot”&ID=“asdghajflerg” where the manufacturer is identified as “abbott” and the encrypted unique identifier is “asdghajflerg”. In other instances, each stored decryption key is used to attempt to decrypt the encrypted unique identifier until the encrypted unique identifier is decrypted. The match module 206 is configured to match the received unique identifier by comparing the received unique identifier to the stored unique identifiers. The match module 206 stores the data received from the manufacturer system 102 along with the appropriate stored unique identifier in the database 212.

The registration module 208, via the consumer device communication module 204, receives consumer registration information from the consumer devices 110 and registers products to the consumer by storing the consumer registration information in association with the unique identifier of the product in the database 212. The consumer registration information identifies the consumer or consumer device 110 that scanned the encoded, encrypted unique identifier. The consumer registration information may include profile information about the consumer including demographic data, location data, PII, allergies, and other data.

The retrieval module 210 is configured to retrieve data from the database 212, such as consumer registration information, product information or updated product information using the stored unique identifiers. The product information is an initial set of information about the product that may be of particular interest to consumers who have recently acquired the product. Examples of product information include a description about the product, an expiration date of the product, recall status of the product, instructions for opening product packaging and using the product, instructions for assembling the product, or the like. The updated product information is a discrete piece of information about the product that informs the consumer of new information about the product or reminds the consumer of product information. Examples of updated product information include recall notices, an alert about an upcoming expiration date, updated instructions for use, information about new uses for the product, class-action notices, or some other notification regarding the product. The retrieval module 210 may further retrieve, for the manufacturer systems 102, stored tracking and usage data about the consumers to whom each product is registered.

The retrieval module 210 is configured to retrieve the product information and updated product information describing the registered products from the database 212. The consumer device communication module 204 is configured to send the retrieved product information and updated product information to the consumer device 110. The product information and updated product information can be retrieved from the database 212 some amount of time after the product is registered to the consumer. The consumer device communication module 204, based on the unique identifiers of products registered to the consumers, sends updated product information about the product or instance corresponding to the unique identifier to the consumer device 110 for display to the consumer.

In some instances, the consumer can request product information without registering the product. For example, the consumer may be choosing from among a number of products at a brick and mortar store while intending to purchase one of the items. The consumer can use the consumer device 110 to scan the encoded, encrypted unique identifier affixed to the product. The consumer device 110 optionally decodes the encoded encrypted unique identifier and sends the scan to the consumer device communication module 204. The match module 206 decrypts and matches the unique identifier to a stored unique identifier. The retrieval module 208 then retrieves product information stored with the stored unique identifier, and the consumer device communication module 204 sends the retrieved information to the consumer device 110. In this example, while the request for product information may be stored in the database 212, the product is not yet registered to the consumer.

The database 212 is configured to store data within a data structure. The database 212 can be internal to the third party server 104, as depicted, or external to the third party server 104. As is apparent to one of ordinary skill in the art, the database 212 can be implemented. Data can be written to, and retrieved from, the database 212 by the various modules described herein. One example of a data structure that can be implemented in the database 212 is depicted in FIG. 8 as described elsewhere herein.

Manufacturers can have additional information to be distributed to consumers that is not product information or updated product information. The additional information may include new product announcements, announcements about the manufacturer or manufacturer's business, press releases, or the like. The additional information is received and stored by the manufacturer communication module 202 along with one or more unique identifiers.

An aggregation module 214 is configured to aggregate the additional information with, for example, product information, updated product information, and marketing offers to the consumers for whom it is relevant. The aggregation module 214 can aggregate information to be sent to the consumer device 110 and displayed in a user interface for displaying the aggregated information, such as a newsfeed.

A marketing module 216 is configured to receive marketing offers from the manufacturer system 102 and to distribute the marketing offers to one or more consumer devices 110. The marketing offer is received by the marketing module 216 along with a target unique identifier from the manufacturer system 102 that is used to identify consumers to whom the marketing offer will be sent. The distribution of marketing offers or advertisements can be performed based on information collected by the usage module 218 (as described elsewhere herein). For instance, users with similar behavior can be grouped and specific advertisements or recommendations made to a specific user by analyzing the usage information of the individual users within the group of users. In some instances, the marketing offer received from the manufacturer system 102 of a manufacturer targets consumers to whom products from other manufacturers have been registered. For example, a marketing offer for Pampers received from the manufacturer Procter and Gamble can be distributed to consumers to whom Similac, manufactured by Abbott, is registered.

In some instances, the manufacturer system 102 can specify criteria for identifying consumers. These criteria can include multiple conditions and involve calculations such as determining a likelihood or probability that certain consumers are interested in a particular product and who are likely to purchase the product. Examples of such calculations that can be performed by the marketing module 216 are known to those skilled in the art. For instance, the criteria may identify consumers above the age of 31 who have purchased three or more bottles of Ensure in the past 3 months. The marketing module 216 identifies, based on the consumer registration information and the products registered to the consumer, consumers who meet these criteria.

A usage module 218 is configured to track usage of a product registered to a consumer. Tracking usage of a product allows a consumer, and/or the manufacturer, to investigate how the product is used or misused. The usage of the product can be tracked based on scans of one or more encoded, encrypted unique identifiers affixed to the product as described further elsewhere herein. Such examples of popular tracking information used by a manufacturer are how many products are used over time or by how many products are used within respective geographical regions. Manufacturers and the third party server 104 can analyze the tracked usage to determine a similarity of individual consumers. This information can be used to, for example, make recommendations to the consumers. Another example of usage information includes information indicating whether the consumer has consumed the product at required or expected consumption times; this information can be used to analyze user compliance. The usage information can be used to increase compliance in the form of reminders sent to consumers as push notifications. In a third example of usage information impacting authentication, a manufacturer can use location information collected as part of the usage information to determine if products have been diverted from an intended geographical market in violation of distribution agreements with distributors or resellers.

The authentication module 220 is configured to authenticate instances of a product. The authentication module 220, after an encrypted unique identifier is decrypted and matched to a stored unique identifier, determines the authenticity of the encrypted unique identifier. If no matching stored unique identifier is found by the match module 206 for the decrypted unique identifier, the decrypted unique identifier is deemed to be fraudulent. The authentication module 220 can send a notification to the consumer device 110 indicating that the unique identifier was previously authenticated by the consumer himself or by another consumer or is fraudulent. In some instances, the product can be marked as fraudulent if certain criteria stored in the database 212 are met, for example if the same unique identifier were scanned from multiple different locations at the same time, that unique identifier is deemed fraudulent or not authentic. If, for example, the same affixed unique identifier is scanned a threshold number of times, a flag can be stored in the database 212 indicating that the product or the registration of the product is fraudulent. In some instances, the authentication data can be displayed in the form of a heat map, according to techniques known to those skilled in the art.

FIGS. 3A and 3B comprise a flowchart of an example method 300 to provide product information to consumers. The method 300 may be performed by the third party server 104 within the computing environment 100.

In an operation 302, product information, a decryption key that can be used to decrypt an encrypted unique identifier, and at least one unique identifier are received by the manufacturer system communication module 202 of the third party server 104 from a manufacturer system 102, as described above. In some instances, the manufacturer has a dedicated manufacturer system 102 for generating this data and sending it to the third party system 104. The manufacturer system communication module 202 may perform operation 302.

In an operation 304, the decryption key is stored in the database 212 by, for example, the manufacturer system communication module 202. The decryption key can be accessed by, for example, the match module 206. As can be appreciated by those skilled in the art, the decryption key can be either a public key or a private key.

In an operation 306, the product information is stored in the database 212 along with the unique identifier. The manufacturer system communication module 202 can store the product information among with the unique identifier in a table or database structure in the database 212, such as that shown in FIG. 8. Tables and databases are well known to those of ordinary skill in the art.

In an operation 308, consumer registration information and an encrypted version of the unique identifier are received from, for example, a consumer device 110. The encrypted version of the unique identifier may be encoded or decoded. The consumer device communication module 204 may perform operation 308.

In an operation 310, the encrypted version of the unique identifier is decrypted using, for example, the stored decryption key of operation 304. As described above, the match module 206 may decrypt the encrypted version of the unique identifier.

In an operation 312, the decrypted unique identifier is matched to the stored unique identifier of operation 306. The matching may be performed by the match module 206.

In an operation 314, the product is registered to the consumer. For example, the registration module 208 registers products or instances of products to the consumer by storing the consumer registration information in association with the matched unique identifier. By registering the product or the instance of the product, the consumer, or someone in the consumer's care (e.g., a child or pet), owns, possesses, has consumed, or will consume the product or the instance of the product to which the unique identifier was affixed. Because registration can occur automatically, or nearly automatically and in real-time, with a scan of an encrypted unique identifier, many current barriers (e.g., filling out an electronic or paper form, providing PII or proof of purchase, and returning the form to the manufacturer) to registration of products by consumers are removed and data about those products can be received by the consumer nearly instantaneously.

In some embodiments, the registration of the product to the consumer can be automatic, performed without human intervention, upon matching the unique identifier. In instances where a unique identifier is affixed to the product such that it is only exposed when the product or packaging is opened, a scan of the exposed unique identifier may automatically cause the third party server 104 to register the product to the consumer. In other instances, the consumer, using the consumer device 110, may indicate intent to register the product by, for example, selecting an option within a graphical user interface of the app running on the consumer devices 110.

Because the registration is performed independently of a purchase transaction, and does not require information about how the product was purchased, the registration is more likely to accurately reflect the end-user (i.e., consumer) of the product. Further, because the registration is performed without payment information (such as a credit card number), sensitive consumer data including PII, need not be collected or shared. Moreover, because products are registered by consumers rather than a purchase transaction history maintained by a retailer, the consumer need not maintain separate accounts with each individual retailer with whom the consumer has transacted. Further, because multiple manufacturers and manufacturer systems 102 can be supported by the third party server 104, the consumer can register a wide range of products from numerous manufacturers purchased via diverse retailers at the third party server 104.

Turning to FIG. 3B, continuing method 300, in an operation 316, the product information corresponding to the matched, stored unique identifier is retrieved. When a consumer registers a product, or a number of products, the retrieval module 210 is configured to retrieve the product information stored by the manufacturer system communication module 202 along with the unique identifier in the database 212.

In an operation 318, the retrieved product information can be sent to the consumer device 110 of the consumer. The consumer device communication module 204 can send the product information.

In an operation 320, updated product information along with one or more unique identifiers is received from the manufacturer system 102. The updated product information can be received by the manufacturer system communication module 202 from the manufacturer system 102. The updated product information is information describing the product that the manufacturer system 102 sends to the third party server 104 subsequent to receiving the product information.

In an operation 322, the unique identifier received along with the updated product information is matched to the stored unique identifier by, for example, the match module 206.

In an operation 324, the updated product information is stored along with the matched, stored unique identifier by, for example, the match module 206.

In an operation 326, the consumer to whom the product is registered is identified using the stored unique identifier and the consumer registration information. The registration module 208 may perform the identification.

In an operation 328, the updated product information is retrieved by, for example, the retrieval module 210.

In an operation 330, the retrieved updated product information is sent to the consumer device 110 of the identified consumer of operation 326. The consumer device communication module 204 may send the retrieved updated product information.

FIG. 4 is a flowchart of an example method 400 to provide additional information, not including product information or updated product information, to consumers. The method 400 can be performed by the aggregation module 214 as described above as part of, for example, aggregating product information, updated product information, and/or additional information into a newsfeed that can be displayed by the consumer device 110.

In an operation 402, additional information relating to the product or the manufacturer along with an associated unique identifier is received from the manufacturer system 102 by, for example, the manufacturer system communication module 202.

In an operation 404, the associated unique identifier is matched to the stored unique identifier by, for example, the match module 206.

In an operation 406, the additional information is stored along with the stored unique identifier by, for example, the manufacturer system communication module 202.

In an operation 408, the consumer is identified based on the consumer registration information stored in association with the stored unique identifier. For example, the match module 206 is configured to identify one or more consumers for whom the additional information is relevant based on products registered to the consumer.

In an operation 410, the additional information stored along with the stored unique identifier is retrieved. The retrieval module 208 retrieves the additional information along with the unique identifier.

In an operation 412, the retrieved additional information is sent across the network to the consumer device 110 by the consumer device communication module 204.

In some embodiments, the aggregation module 214 generates a newsfeed or other graphical user interface to be sent to the consumer device 110. The aggregation module 214, in some instances, can aggregate product information and updated product information along with the additional information included in the newsfeed or other interface. As more products are registered to each consumer, the more unique identifiers are received along with the consumer registration information. In turn, the consumer registration information is stored in association with a greater number of stored unique identifiers. A significant amount of additional information can be associated with a particular consumer. The aggregation module 214 may aggregate the additional information to be sent to the consumer device 110 as part of a newsfeed. In the newsfeed, more recently added additional information can be located near the top of the interface while previously received additional information persists below the recently added additional information. Other interfaces known to those skilled in the art may be used to present the additional information.

FIG. 5 is a flowchart of an example method 500 to provide marketing offers to consumers. The method 500 may be performed by, for example, the marketing module 216.

In an operation 502, a marketing offer is received from the manufacturer system 102. The marketing offer may be received along with a target unique identifier, target product information, or other criteria. The marketing offers may include purchase discounts on products already registered to the consumer, purchase discounts on products that have not been registered to the consumer, and purchase discounts on products that the consumer is likely to purchase based on other products registered to the consumer. The marketing offer may be redeemed by the consumer upon purchasing or registering the product that is the subject of the marketing offer. In other instances, the redemption of the marketing offer can trigger or initiate a request that the consumer register the newly purchased product.

Other criteria that can be received along with the marketing criteria include consumer demographic characteristics, other products registered to consumers, or other products purchased by consumers. The marketing module 216 may perform one or more calculations to determine, based on the criteria and the consumer registration information and products registered to the consumer, a likelihood that the consumer will purchase the product featured by the marketing offer. In some instances, general analytics information about the identified consumers can be provided to the manufacturer systems 102. The general analytics information need not identify the individual consumers, thus preserving the privacy of the consumers.

In an operation 504, a stored unique identifier is matched to the marketing offer. If the marketing offer was received along with the target unique identifier, the target unique identifier is matched to one of the stored unique identifiers. In some instances, the match module 206 matches the target unique identifier to the stored unique identifier. The identified consumers are those corresponding to the consumer registration information stored in association with the matched stored unique identifier.

In an operation 506, the marketing offer is sent, over the network 106, to the consumer device 110 of a consumer using the consumer registration information stored in association with the stored unique identifier. For example, the marketing module 216 distributes the marketing offer to one or more identified consumers to whom the product corresponding to the target product identifier is registered.

In another embodiment, in the operation 502, the manufacturer system communication module 202 is configured to receive, from the manufacturer system 102, the marketing offer along with target product information. The target product information describes one or more products sold by the manufacturer or by another manufacturer and registered to one or more consumers. The target product information can include a product name or description, a target demographic associated with the product, a manufacturer identity, and other information. The marketing module 216 is configured to determine that the target product information corresponds to the stored product information. The match module 206, using the stored product information, identifies the stored unique identifier. For example, the marketing module 216 may receive target product information of “diapers” and determines that stored product information includes “disposable diapers”. The match module 206 then matches the stored product information “disposable diapers” to a set of stored unique identifiers.

The marketing module 216 is configured to distribute the marketing offer to one or more identified consumers to whom the products corresponding to the target product information is registered. Using the stored unique identifiers and the consumer registration information, one or more consumers are identified by the match module 206. The consumer device communication module 202 sends, over the network 106, the marketing offer to the consumer devices 110 of the identified consumers using the consumer registration information stored in association with the stored unique identifiers.

Because the manufacturer does not send the marketing offers directly to the consumer devices 110, the manufacturer need not have access to or even knowledge of the consumer registration information. The marketing module 216 can ensure that the manufacturer does not receive the consumer registration information identifying the consumers. In this way, any PII or other data of the consumer known to the third party server 104 can be kept secret from the manufacturer system 102 and therefore the manufacturer. As such, consumer privacy concerns are alleviated and compliance with consumer privacy regulations is achieved.

FIG. 6 is a flowchart of an example method 600 to track usage or consumption by consumers of a product. The method 600 may be performed by, for example, the usage module 218. The method 600 may be performed as part of method 300 or after method 300 is performed.

To track usage or consumption of the product, the consumer is instructed to capture the encoded, encrypted unique identifier just before using or consuming the product. At an operation 602, a timestamp is received by the consumer device communication module 202 indicating a time when the scan of the encoded, encrypted unique identifier was captured by a consumer device 110. In other embodiments, the usage module 218 may assign a timestamp indicating when a scan of the unique identifier was received from the consumer device 110.

In some embodiments, the unique identifier is assigned to just one instance of the product. As such, each instance of the product is assigned a distinct unique identifier. For example, each pharmaceutical pill or tablet may be assigned a unique identifier that is affixed to a particular blister in a blister pack containing the pills or tablets. The consumer is instructed to scan, using the consumer device 110, the encrypted unique identifier corresponding to an instance, then open the blister containing the instance and thereby destroying the affixed, encrypted unique identifier, then consume the instance immediately thereafter.

In embodiments where the product identifier identifies more than one instance of the product, the usage module 218 determines that the stored unique identifier matched to encrypted unique identifier via the match module 206 was previously scanned by the consumer device 110. In some instances, the usage module 218 can determine that the product was consumed based on product information indicating that the scanned unique identifier was affixed to the product in such a way as to only be exposed when the product packaging is opened or unsealed. The usage module 218 then determines, based on the product information, whether the product is single-use or can be used multiple times. If the product is single-use, the usage module 218 instructs the registration module 208 to register the product to the user. The usage module 218 may record an indication that the user has repeatedly used the single-use product.

At an operation 604, the timestamp is compared to an expected time of consumption of a product corresponding to a stored unique identifier. The usage module 218, after the encrypted unique identifiers are decrypted and matched to a stored unique identifier, is configured to access or assign a time of consumption by the consumer. The usage module 218 then determines, based on the product information stored along with the stored unique identifier, whether the time of consumption matches (or is within an expected range of) an expected time of consumption or an anticipated interval of consumption of two or more instances of the product. The expected time of consumption may indicate an expiration date, a date the instance was delivered to the consumer (e.g., if registered by the consumer or provided to the third party server 104 by a pharmacist), or a time interval calculated from a previous scan of a unique identifier indicating consumption by the consumer of another instance of the product or of another product.

From the product information, the usage module 218 may further determine if the unique identifier is one of a group of unique identifiers affixed within a single package containing multiple instances, for example, a blister pack. The usage module 218 may track consumption of the instances and determine whether the consumer is correctly using the product. The usage module 218 may further determine, based on an expected time of consumption, that the consumer has missed a dosage if the consumer has failed to register the product at, before, or within a pre-defined time after the expected time of consumption.

At an operation 606, a notification indicating the result of the operation 604 comparison is sent to, for example, the consumer device 110, the manufacturer, or to an authority. In some instances, the consumer may be prompted to scan an encrypted unique identifier prior to the expected time of consumption by sending a dosage reminder notification to the consumer device 110. If the usage module 218 determines that the consumer has likely missed a dose because no scan was received, the usage module 218 can send, via the consumer device communication module 202, a reminder notification to the consumer device 110 of the consumer alerting the consumer to the missed dose. If the product information includes instructions in case a dose is missed, the reminder notification may include those instructions.

If indicated by the product information, the usage module 218 may notify an authority that one or more doses were missed as part of the operation 606. The authority can include medical professionals, social workers, and/or government authorities. The authorities may provide instructions for the consumer to, for example, consume any remaining doses, to seek medical treatment, or to properly dispose of any unconsumed doses.

At an operation 608, instructions are retrieved from, for example, the product information stored along with the unique identifier, the manufacturer, or an authority.

At an operation 610, the instructions are sent to the device of the consumer by the consumer device communication module 204. In some instances, the usage module 218 may receive feedback from the consumer via the consumer device 110. The feedback may include descriptions of side effects or symptoms experienced upon taking a dosage of a pharmaceutical product. The usage module 218 may retrieve updated dosing instructions from the stored product information or from the manufacturer. The usage module 218 may send the updated dosing instructions to the consumer device 110.

FIG. 7 is a flowchart of an example method 700 to identify fraudulent uses of the product. The method 700 may be performed by, for example, the authentication module 714.

In an operation 702, a determination is made that a decrypted unique identifier that identifies an instance of a product was previously used to register a product. In some instance, when the stored unique identifier identifies more than one instance of the product, the authentication module 220 may determine that the encrypted unique identifier or the decryption key used to decrypt the encrypted unique identifier is stale or out-of-date. When the encrypted unique identifier is specific to one instance of the product, the authentication module 220 can determine that the unique identifier was used by another consumer to register the product to the other consumer. In instances where the instance of the product is a one-time-use product, the authentication module 220 can determine that the product was previously registered to the consumer attempting to authenticate the instance.

In an operation 704, a notification is sent by the consumer device communication module 204. The notification may be sent by the consumer device communication module 204 to the consumer device 110 from which the encrypted unique identifier was received or by the manufacturer system communication module 202 to the manufacturer system 102. The authentication module 220 can additionally send, via the manufacturer system communication module 202, a notification to the manufacturer system 102 indicating that the unique identifier has been authenticated more than once. In some instances, the manufacturer can direct a retailer to remove an unauthenticated item from its saleable inventory.

FIG. 8 is an example of a data structure 800 in which data is stored according to various embodiments. The data structure 800 is provided merely as an illustration of one possible way to structure the stored data described herein. Based on the provided description, those of ordinary skill in the art will appreciate that other known data structures can be used and implemented.

The data structure 800 comprises a table having multiple columns. In the first column are stored unique identifiers received from, for example, the manufacturer system 102. The subsequent columns, depicted to the right of the first column, data that is stored along with, or in association with, the stored unique identifiers based on matching unique identifiers. When product information, updated product information, or consumer registration information is received along with a unique identifier, a further column is populated in the row contained the stored unique identifier. Each time an additional unique identifier is received, a new row is created in the table of FIG. 8.

In some instances, 2-way communication between the consumer device 108 and one of: the third party server 104, the manufacturer system 102, or an authority can be established. To initiate the two-way communication, the consumer can scan the affixed unique identifier such that the consumer need not repeat identification, product or location information during the two-way communication. The two-way communication can be established using techniques known to those skilled in the art, including voice, chat, email, etc. as used for customer support or feedback.

Using the systems and methods described herein, consumers can more easily register products and receive information about the products without relying on a retailer. Further, manufacturers are better able to track usage of products and contact consumers of the products with updated information. The third party server can distribute marketing offers while still preserving consumer privacy.

The disclosed method and apparatus has been explained above with reference to several embodiments. Other embodiments will be apparent to those skilled in the art in light of this disclosure. Certain aspects of the described method and apparatus may readily be implemented using configurations other than those described in the embodiments above, or in conjunction with elements other than those described above. For example, different algorithms and/or logic circuits, perhaps more complex than those described herein, may be used.

Further, it should also be appreciated that the described method and apparatus can be implemented in numerous ways, including as a process, an apparatus, or a system. The methods described herein may be implemented by program instructions for instructing a processor to perform such methods, and such instructions recorded on a non-transitory computer readable storage medium such as a hard disk drive, floppy disk, optical disc such as a compact disc (CD) or digital versatile disc (DVD), flash memory, etc., or communicated over a computer network wherein the program instructions are sent over optical or electronic communication links. It should be noted that the order of the steps of the methods described herein may be altered and still be within the scope of the disclosure.

It is to be understood that the examples given are for illustrative purposes only and may be extended to other implementations and embodiments with different conventions and techniques. While a number of embodiments are described, there is no intent to limit the disclosure to the embodiment(s) disclosed herein. On the contrary, the intent is to cover all alternatives, modifications, and equivalents apparent to those familiar with the art.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method at a third party server comprising:
receiving, across a network and from a manufacturer system, product information, a decryption key, and a unique identifier, the product information describing a product to which an encrypted version of the unique identifier is affixed by the manufacturer;
storing the decryption key;
storing the product information along with the unique identifier received from the manufacturer system;
receiving, across the network and from a device of a consumer, consumer registration information and a scan of the encrypted version of the unique identifier, the consumer registration information including an identification of the consumer;
decrypting the received encrypted version of the unique identifier using the stored decryption key, resulting in a decrypted unique identifier;
matching the stored unique identifier to the decrypted unique identifier;
registering the product to the consumer by storing the consumer registration information in association with the stored unique identifier;
retrieving the product information stored along with the stored unique identifier;
sending the retrieved product information across the network to the device of the consumer;
receiving, across the network and from the manufacturer system, updated product information along with the unique identifier;
matching the unique identifier received with the updated product information to the stored unique identifier;
storing the updated product information along with the stored unique identifier;
identifying the consumer to whom the product is registered using the consumer registration information stored in association with the stored unique identifier;
retrieving the updated product information stored along with the stored unique identifier; and
sending the retrieved updated product information across the network to the device of the consumer.

2. The method of claim 1, further comprising generating a newsfeed comprising additional information based on the consumer registration information by:
receiving additional information relating to the product or the manufacturer along with an associated unique identifier;
matching the associated unique identifier to the stored unique identifier;
storing the additional information along with the stored unique identifier;
identifying the consumer based on the consumer registration information stored in association with the stored unique identifier;
retrieving the additional information stored along with the stored unique identifier; and
sending the retrieved additional information across the network to the device of the consumer.

3. The method of claim 1, further comprising:
receiving, from the manufacturer, a marketing offer along with a target unique identifier; and
distributing the marketing offer, the distributing consisting of:
matching the target unique identifier to the stored unique identifier to identify the consumer, and
sending, over the network, the marketing offer to the device of the identified consumer using the consumer registration information stored in association with the stored unique identifier.

4. The method of claim 1, further comprising:
receiving, from the manufacturer, a marketing offer along with target product information; and
distributing the marketing offer, the distributing consisting of:
matching the target product information to the stored product information to identify the stored unique identifier,
identifying the consumer, and
sending, over the network, the marketing offer to the device of the identified consumer using the consumer registration information stored in association with the stored unique identifier.

5. The method of claim 1, wherein the stored unique identifier identifies a first instance of the product and the method further comprises tracking usage of the first instance of the product by:
receiving, from the device of the consumer, a first timestamp indicating when the scan of the encrypted version of the stored unique identifier was captured by the device of the consumer;
storing the first timestamp in association with the stored unique identifier;
comparing the first timestamp to an expected time of consumption; and
sending a notification to the device of the consumer based on the comparison.

6. The method of claim 5, further comprising:
receiving, from the device of the consumer, a second timestamp indicating when a scan of an encrypted version of a second unique identifier corresponding to a second instance of the product was captured by the device of the consumer; and
storing the second timestamp in association with the second unique identifier.

7. The method of claim 6, further comprising:
determining a time interval between the first timestamp and the second timestamp;
comparing the time interval to an expected interval included in the product information;
notifying the manufacturer system or an authority of a result of the comparison.

8. The method of claim 7, further comprising:
based on the result of the comparison of the time interval and the decrypted unique identifier, accessing instructions from the manufacturer or an authority; and
sending the instructions to the device of the consumer.

9. The method of claim 5, wherein the first timestamp is included in the consumer registration information.

10. The method of claim 1, wherein the decrypted unique identifier identifies an instance of the product and the method further comprises detecting fraudulent uses of the instance of the product by:
after matching the decrypted unique identifier to a stored unique identifier, determining that the stored unique identifier was previously registered.

11. The method of claim 10, wherein the stored unique identifier was registered by the consumer.

12. The method of claim 10, wherein the stored unique identifier was registered to another consumer.

13. The method of claim 10, further comprising sending a notification to the device of the consumer indicating that the decrypted unique identifier was previously authenticated.

14. The method of claim 10, further comprising send a notification to the manufacturer system indicating that the decrypted unique identifier has been authenticated more than once.

15. The method of claim 1, further comprising initiating two-way communication with the device of the consumer upon receiving the consumer registration information and the scan of the encrypted version of the unique identifier.

16. The method of claim 1, further comprising:
receiving, from the manufacturer, a marketing offer along with criteria for identifying consumers; and
distributing the marketing offer, the distributing consisting of:
matching the criteria to the consumer registration information to identify the consumer, and
sending, over the network, the marketing offer to the device of the identified consumer using the consumer registration information.

17. A system comprising:
a manufacturer system communication module configured to receive, across a network and from a manufacturer system, product information, a decryption key, and a unique identifier, the product information describing a product to which an encrypted version of the unique identifier is affixed by the manufacturer, to store the decryption key, and to store the product information along with the unique identifier received from the manufacturer system;
a consumer device communication module configured to receive, across the network and from a device of a consumer, consumer registration information and a scan of the encrypted version of the unique identifier, the consumer registration information including an identification of the consumer;
a match module configured to decrypt the received encrypted version of the unique identifier using the stored decryption key, resulting in a decrypted unique identifier, and to match the decrypted unique identifier to the stored unique identifier;
a registration module configured to register the product to the consumer by storing the consumer registration information in association with the stored unique identifier; and
a retrieval module configured to retrieve the product information stored along with the stored unique identifier and
wherein the consumer device communication module is further configured to send the retrieved product information across the network to the device of the consumer,
wherein the manufacturer system communication module is further configured to receive, across the network and from the manufacturer system, updated product information along with the unique identifier,
wherein the match module is configured to match the unique identifier received with the updated product information to the stored unique identifier, and to store the updated product information along with the stored unique identifier,
wherein the match module is further configured to identify the consumer to whom the product is registered using the consumer registration information stored in association with the stored unique identifier,
wherein the retrieval module is further configured to retrieve the updated product information stored along with the stored unique identifier, and
wherein the consumer device communication module is further configured to send the retrieved updated product information across the network to the device of the consumer.

18. A non-transitory computer-readable medium having instruction embodied thereon, the instructions executable by one or more processors to perform operations comprising:
receiving, across a network and from a manufacturer system, product information, a decryption key, and a unique identifier, the product information describing a product to which an encrypted version of the unique identifier is affixed by the manufacturer;
storing the decryption key;
storing the product information along with the unique identifier received from the manufacturer system;
receiving, across the network and from a device of a consumer, consumer registration information and a scan of the encrypted version of the unique identifier, the consumer registration information including an identification of the consumer;
decrypting the received encrypted version of the unique identifier using the stored decryption key, resulting in a decrypted unique identifier;
matching the stored unique identifier to the decrypted unique identifier;
registering the product to the consumer by storing the consumer registration information in association with the stored unique identifier;
retrieving the product information stored along with the stored unique identifier;
sending the retrieved product information across the network to the device of the consumer;
receiving, across the network and from the manufacturer system, updated product information along with the unique identifier;
matching the unique identifier received with the updated product information to the stored unique identifier;
storing the updated product information along with the stored unique identifier;
identifying the consumer to whom the product is registered using the consumer registration information stored in association with the stored unique identifier;
retrieving the updated product information stored along with the stored unique identifier; and
sending the retrieved updated product information across the network to the device of the consumer.
